(19) United States
(12) Patent Application Publication
(10) Pub. No.: US 2025/0126498 A1
(43) Pub. Date: Apr. 17, 2025

(54) ELECTRONIC DEVICE TO MONITOR WIRELESS NETWORK ENVIRONMENT WITH LOW POWER CONSUMPTION AND METHOD THEREOF

(71) Applicant: MediaTek Singapore Pte. Ltd., Singapore (SG)

(72) Inventor: Zhuoliang ZHANG, Beijing (CN)

(21) Appl. No.: 18/507,376

(22) Filed: Nov. 13, 2023

(30) Foreign Application Priority Data
Oct. 16, 2023 (CN) 202311339115.9

(51) Int. Cl. H04W 24/08; H04B 17/318

(52) U.S. Cl. CPC H04W 24/08; H04B 17/318

(57) ABSTRACT

An electronic device includes a wireless monitor, a TX delay monitor, and a wireless network environment checker. The wireless monitor outputs a TX data packet in response to receiving data from a user space. The TX delay monitor receives the TX data packet and calculates a TX delay associated with the TX data packet. The wireless network environment checker checks the network communication environment in response to receiving a warning signal from the wireless monitor. The TX delay monitor sends a TX delay event to the wireless monitor in response to the TX delay associated with the TX data packet being longer than a predetermined period. The wireless monitor sends the warning signal to the wireless network environment checker based on the TX delay event.

### CROSS REFERENCE TO RELATED APPLICATIONS

This application claims the benefit of China Application No. 202311339115.9, filed Oct. 16, 2023, the entirety of which is incorporated by reference herein.

### BACKGROUND OF THE INVENTION

### Field of the Invention

The present invention relates to an electronic device, and, in particular, to an electronic device to monitor the wireless network environment with low power consumption, and the method thereof.

### Description of the Related Art

In recent years, with the development of mobile communication technology, wireless network applications such as mobile games and mobile live broadcast have become popular. In order to provide a better user experience, R&D personnel have done a lot of work on wireless network optimization on mobile phones. Theses optimization schemes first need to detect the status of the wireless network, and then make corresponding optimization adjustments.

The common method for detecting the wireless network environment includes perceiving wireless signal quality by querying Received Signal Strength Indication (RSSI) at high frequency, perceiving network latency by continuously allowing mobile devices to interact with remote services (such as ping server IP), or monitoring link bandwidth by continuously testing the bandwidth of the mobile device and the remote service.

The above-mentioned method of monitoring one or more network environment parameters is obviously a low-efficiency monitoring method. More importantly, the above-mentioned method consumes a lot of power, which is very critical for mobile devices.

### BRIEF SUMMARY OF THE INVENTION

An embodiment of the present invention provides an electronic device. The electronic device includes a wireless monitor, a TX delay monitor, and a wireless network environment checker. The TX delay monitor calculates a TX delay associated with a TX data packet. The wireless network environment checker checks the network communication environment in response to receiving a warning signal from the wireless monitor. The TX delay monitor sends a TX delay event to the wireless monitor in response to the TX delay associated with the TX data packet being longer than a predetermined period. The wireless monitor sends the warning signal to the wireless network environment checker based on the TX delay event.

According to the electronic device described above, the wireless monitor performs a core algorithm to monitor the TX delay event from the TX delay monitor, set parameters of the TX delay monitor, receive the TX delay event from the TX delay monitor, and send the warning signal to the wireless network environment checker based on the TX delay event.

According to the electronic device described above, the TX delay monitor calculates the TX delay associated with the TX data packet, and send the TX delay event to the wireless monitor in response to the TX delay associated with the TX data packet being longer than the predetermined period.

According to the electronic device described above, the wireless network environment checker checks one or more of the wireless signal Received Signal Strength Indication (RSSI), network latency, and network bandwidth in response to receiving the warning signal from the wireless monitor.

According to the electronic device described above, the TX delay monitor performs the TX delay monitor driver to record a first time point at which the TX data packet is sent to a hardware queue. The TX delay monitor performs the TX delay monitor driver to record a second time point at which the TX delay monitor receives an acknowledgement message from a router. The second time point is later than the first time point.

According to the electronic device described above, the TX delay monitor calculates the TX delay associated with the TX data packet by subtracting the first time point from the second time point.

According to the electronic device described above, the TX delay monitor is comprised in a wireless network device having a hardware queue for preparing to transmit the TX data packet to the router.

According to the electronic device described above, the acknowledgement message from the router is a layer-2 (L2) acknowledgement message.

According to the electronic device described above, the electronic device is connected to a network server through the router.

According to the electronic device described above, the TX delay monitor receives an Internet Protocol (IP) packet from the network server at a third time point. The third time point is later than the second time point.

According to the electronic device described above, the parameters of the TX delay monitor comprise the predetermined period.

An embodiment of the present invention also provides a method to monitor the wireless network environment with low power consumption. The method is applied to an electronic device including a wireless monitor, a TX delay monitor, and a wireless network environment checker. The method includes the following stages. The TX delay monitor sends a TX delay event in response to the TX delay associated with the TX data packet being longer than a predetermined period. The wireless monitor sends a warning signal to the wireless network environment checker based on the TX delay event. The wireless network environment checker checks the network communication environment in response to receiving the warning signal from the wireless monitor.

According to the method described above, the step of the TX delay monitor calculating the TX delay associated with the TX data packet includes the following stages. The TX delay monitor records a first time point at which the TX data packet is sent to a hardware queue. The TX delay monitor records a second time point at which the TX delay monitor receives an acknowledgement message from a router. The TX delay monitor calculates the TX delay associated with the TX data packet by subtracting the first time point from the second time point.

According to the method described above, the hardware queue stores the TX data packet prepared for transmitting to the router.

According to the method described above, the second time point is later than the first time point.

According to the method described above, the step of the wireless network environment checker checking the network communication environment in response to receiving the warning signal from the wireless monitor includes the following stage. The wireless network environment checker checks one or more of the wireless signal RSSI, network latency, and network bandwidth in response to receiving the warning signal from the wireless monitor.

The method further includes the following stages. The wireless monitor monitors the TX data packet. The wireless monitor sets parameters of the TX delay monitor. The wireless monitor receives the TX delay event from the TX delay monitor.

According to the method described above, the parameters of the TX delay monitor comprise the predetermined period.

The method further includes the following stage. The TX delay monitor receives an Internet Protocol (IP) packet from a network server at a third time point.

According to the method described above, the third time point is later than the second time point.

### BRIEF DESCRIPTION OF THE DRAWINGS

The present invention can be more fully understood by reading the subsequent detailed description and examples with references made to the accompanying drawings, wherein:

FIG. 1 is a schematic diagram of an electronic device 100, a router 102, and a network server 104 in accordance with some embodiments of the present invention.

FIG. 2 is a schematic diagram of definitions of a TX delay calculated by a TX delay monitor 110 in FIG. 1 in accordance with some embodiments of the present invention.

FIG. 3 is a flow chart of a method to monitor the wireless network environment with low power consumption applied to the electronic device 100 in FIG. 1 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without departing from the spirit of the present invention.

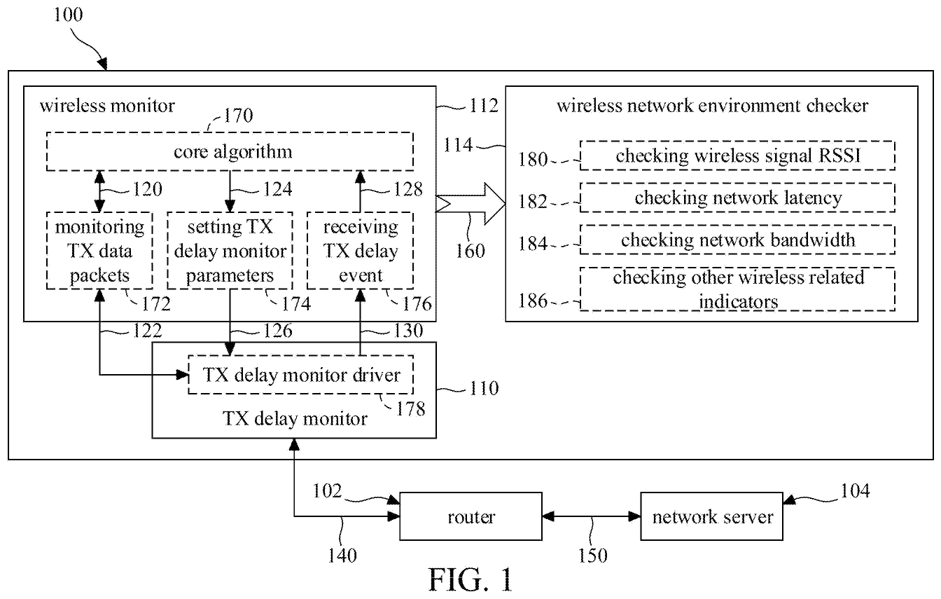

FIG. 1 is a schematic diagram of an electronic device 100, a router 102, and a network server 104 in accordance with some embodiments of the present invention. In some embodiments, the electronic device 100 may be user equipment (UE), such as a smart phone, a tablet, a laptop, or a machine type communication (MTC) device, but the present invention is not limited thereto. In some embodiments, the router 102 may be a Wi-Fi Hotspot, an Evolved Node B (eNB), or a Next-Generation Node B (gNB), but the present invention is not limited thereto. In some embodiments, the network server 104 may include a Wireless LAN (WLAN), or an Evolved-Universal Terrestrial Radio Access Network (E-UTRAN) and an Evolved Packet Core (EPC), or a Next-Generation Radio Access Network (NG-RAN) and a Next-Generation Core Network (NG-CN), but the present invention is not limited thereto.

As shown in FIG. 1, the electronic device 100 includes a TX delay monitor 110, a wireless monitor 112, and a wireless network environment checker 114. In some embodiments, the TX delay monitor 110, the wireless monitor 112, and the wireless network environment checker 114 may be disposed in one or more processors, but the present invention is not limited thereto. In some embodiments, the TX delay monitor 110, the wireless monitor 112, and the wireless network environment checker 114 may be one or more processors, but the present invention is not limited thereto.

In some embodiments, the TX delay monitor 110 is included in a wireless network device, but the present invention is not limited thereto. The user space may be an application executed on the electronic device 100, but the present invention is not limited thereto. The TX delay monitor 110 sends a TX delay event to the wireless monitor 112 in response to the TX delay associated with the TX data packet being longer than a predetermined period. The wireless monitor 112 sends a warning signal to the wireless network environment checker 114 through a data path 160 based on the TX delay event.

In some embodiments, the wireless monitor 112 performs a core algorithm 170 to monitor the TX delay event (block 172) through data paths 120 and 122, set parameters of the TX delay monitor 110 (block 174) through data paths 124 and 126, receive the TX delay event from the TX delay monitor (block 176) through data paths 130 and 128, and send the warning signal to the wireless network environment checker 114 based on the TX delay event. In some embodiments, the parameters of the TX delay monitor 110 set by the core algorithm 170 include the predetermined period. The predetermined period is a threshold period set by the core algorithm 170.

In some embodiments, the TX delay monitor 110 calculates a TX delay associated with a TX data packet. In some embodiments, the TX delay monitor 110 performs a TX delay monitor driver 178 to calculate the TX delay associated with the TX data packet, and send the TX delay event to the wireless monitor 112 in response to the TX delay associated with the TX data packet being longer than the predetermined period. In some embodiments, the TX data packet is received by a network interface (not shown) in the electronic device 100, but the present invention is not limited thereto. In some embodiments, the TX data packet is sent from a user space, but the present invention is not limited thereto.

For example, the TX delay monitor 110 performs the TX delay monitor driver 178 to record a first time point at which the TX data packet is sent to a hardware queue in the wireless network device. The hardware queue stores the TX data packet prepared for transmitting to the router 102. The TX delay monitor 110 performs the TX delay monitor driver 178 to record a second time point at which the TX delay monitor 110 receives an acknowledgement message from the router 102. The second time point is later than the first time point. After that, the TX delay monitor 110 calculates the TX delay associated with the TX data packet by subtracting the first time point from the second time point. The TX delay monitor 110 performs the TX delay monitor driver 178 to send the TX delay event to the wireless monitor 112 in response to the TX delay associated with the TX data packet being longer than the predetermined period.

In some embodiments, the wireless network environment checker 114 checks one or more of the wireless signal Received Signal Strength Indication (RSSI) (block 180), network latency (block 182), network bandwidth (block 184), and other wireless related indicators (block 186) in response to receiving the warning signal from the wireless monitor 112. In some embodiments, the other wireless related indicators may include idle time, but the present invention is not limited thereto. The wireless related indicators detected by the wireless network environment checker 114 depend on the optimization purpose or specific requirements.

In some embodiments, when the electronic device 100 is turned on, the wireless monitor 112 is initialized. During the initialization, the core algorithm 170 sets the parameters of the TX delay monitor 110 through the TX delay monitor driver 178 (for example, block 174). For example, a threshold period of 5 ms and a threshold interval of 200 ms are set. After that, the wireless monitor 112 starts to monitor the TX delay event. When the wireless network environment becomes worse, the TX delay monitor 110 performs the TX delay monitor driver 178 to calculate a TX delay of 10 ms. Therefore, the TX delay monitor 110 performs the TX delay monitor driver 178 to send a TX delay event to the wireless monitor 112 in response to the TX delay (for example, 10 ms) associated with the TX data packet being longer than a predetermined period (for example, 5 ms).

Then, the wireless monitor 110 performs the core algorithm 170 to receive the TX delay event from the TX delay monitor 112. In some embodiments, the wireless monitor 112 records this TX delay event (for example, the TX delay of 10 ms), but does not send a warning signal to the wireless network environment check 114. In some embodiments, when the wireless monitor 112 receives 5 consequent TX delay events that are shorter than 20 ms during 500 ms, or obtains one TX delay event that is longer than 20 ms, the wireless monitor 112 sends the warning signal to the wireless network environment check 114 through the data path 160. After that, the wireless network environment checker 114 checks one or more of the wireless signal Received Signal Strength Indication (RSSI), network latency, and network bandwidth in response to receiving the warning signal from the wireless monitor 112.

After the wireless network environment checker 114 obtains the results from blocks 180 to 186 in FIG. 1, the wireless network environment checker 114 performs network quality evaluation calculations to provide an evaluation result of the real-time wireless environment. In some embodiments, if the evaluation result is bad, the wireless network environment checker 114 sends the evaluation result to the user space. In some embodiments, the wireless network environment checker 114 performs network quality evaluation calculations based on a benchmark obtained from a specification through the network. After the user space receives the evaluation result from the wireless network environment checker 114, the user space may perform optimization and adjustment by adjusting the resolution to reduce bandwidth usage, or switching to other networks and other strategies.

In some embodiments, when the wireless monitor 112 figures out that there is no TX data packet during 100 ms, the wireless monitor 112 may actively send a ping packet to the router 102 to avoid no monitoring events during long time.

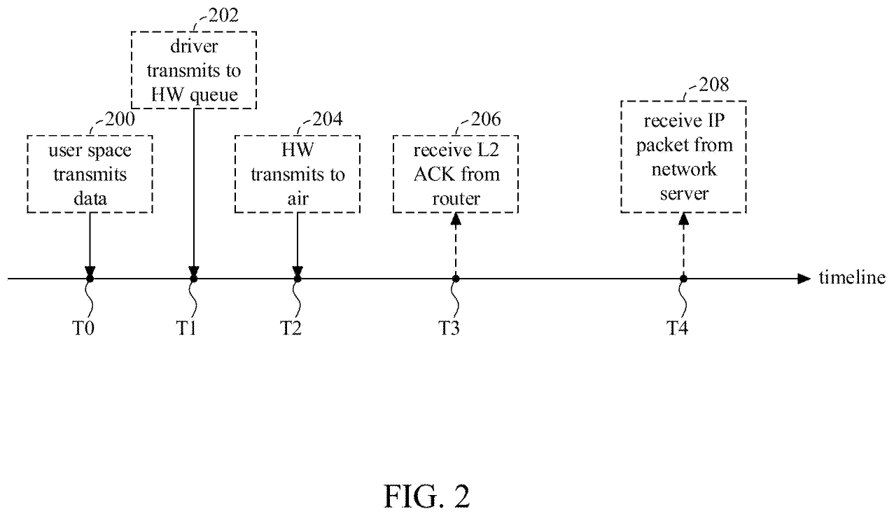

FIG. 2 is a schematic diagram of definitions of a TX delay calculated by a TX delay monitor 110 in FIG. 1 in accordance with some embodiments of the present invention. Please refer to FIG. 1 and FIG. 2 at the same time. As shown in FIG. 2, at time point TO, a user space transmits data to the electronic device 100 (block 200). In some embodiments, the user space may be an application executed on the electronic device 100, but the present invention is not limited thereto.

In detail, the TX delay monitor 110 is included in a wireless network device having a hardware queue for preparing to transmit the TX data packet to the router 102. The TX delay monitor driver 178 is included in a wireless network interface driver. Therefore, after receiving the TX data packet from the wireless monitor 112, at time point T2, the wireless network interface driver sends the TX data packet into the hardware queue in the wireless network device (block 202). In some embodiments, the period from time point TO to time point T1 is regarded as a driver delay.

At time point T2, the TX delay monitor 110 (or the wireless network device) transmits the TX data packet stored in the hardware queue to the air (block 204), for example, by an antenna, and for example, through a data path 140 in FIG. 1. In some embodiments, the period from time point T1 to time point T2 is regarded as hardware queue buffering time.

When the router 102 receives the TX data packet from the electronic device 100, the router 102 sends an acknowledgement message back to the electronic device 100, and forwards the TX data packet to the network server 104, for example, through a data path 150 in FIG. 1. In some embodiments, the acknowledgement message from the router 102 is a layer-2 (L2) acknowledgement (ACK) message, but the present invention is not limited thereto. At time point T3, the TX delay monitor 110 receives the acknowledgement message from the router 102 (block 206). In some embodiments, the TX delay of the present invention is defined as the period from time point T1 to time point T3, but the present invention is not limited thereto.

After the network server 104 receives the TX data packet forwarded by the router 102, the network server 104 sends an Internet Protocol (IP) packet to the electronic device 100. The router 102 then forwards the IP packet, and the TX delay monitor 110 receives the IP packet from the network server 104 at time point T4 (block 208). Since the TX delay of the present invention is defined as the period from time point T1 to time point T3, the TX delay may fully response the interference or scene of wireless environment where the user is located.

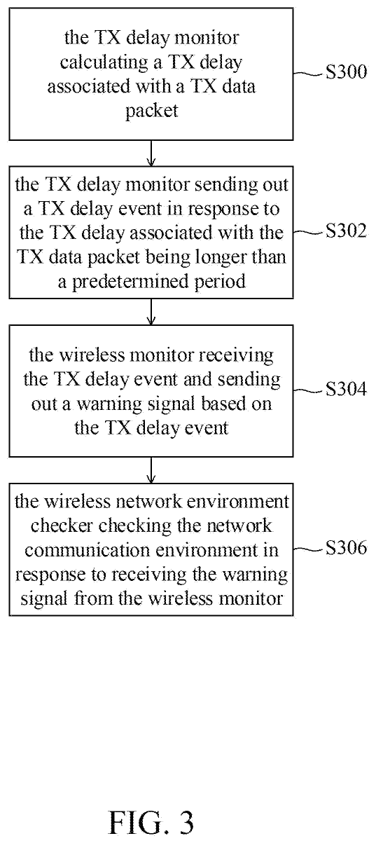

FIG. 3 is a flow chart of a method to monitor the wireless network environment with low power consumption applied to the electronic device 100 in FIG. 1 in accordance with some embodiments of the present invention. As shown in FIG. 3, the method of the present invention includes the following stages. The TX delay monitor 110 calculates a TX delay associated with a TX data packet (step S300). The TX delay monitor 110 sends a TX delay event in response to the TX delay associated with the TX data packet being longer than a predetermined period (step S302). The wireless monitor 112 receives the TX delay event and sends out a warning signal to the wireless network environment checker 114 based on the TX delay event (step S304). The wireless network environment checker 114 checks the network communication environment in response to receiving the warning signal from the wireless monitor 112 (step S306).

In some embodiments, before step S300 is performed, the wireless monitor 112 sets parameters of the TX delay monitor 110. For example, the parameters include the predetermined period in step S302, but the present invention is not limited thereto. In step S300, the TX delay monitor 110 records a first time point (for example, time point T1 in FIG. 2) at which the TX data packet is sent to a hardware queue. The TX delay monitor 110 records a second time point (for example, time point T3 in FIG. 2) at which the TX delay monitor 110 receives an acknowledgement message from the router 102. The TX delay monitor 110 calculates the TX delay associated with the TX data packet by subtracting the first time point from the second time point. That is the TX delay is equal to the period from time point T1 to time point T3 in FIG. 2. In some embodiments, the TX delay monitor 110 receives an IP packet from the network server 114 at a third time point (for example, time point T4 in FIG. 2).

In step S302, the wireless monitor 112 receives the TX delay event from the TX delay monitor 110, and then step S304 is performed. In step S304, the wireless monitor 306 may directly send the warning signal to the wireless network environment checker 114 based on the TX delay event. In some embodiments, the wireless monitor 112 may record the TX delay event, but do not send the warning signal to the wireless network environment checker 114. The strategy for the wireless monitor 112 to send out the warning signal is set during initialization after the electronic device 100 is turned on.

In step S306, the wireless network environment checker 114 checks one or more of the wireless signal RSSI, network latency, and network bandwidth in response to receiving the warning signal from the wireless monitor 112, but the present invention is not limited thereto.

The electronic device 100 and the method to monitor the wireless network environment with low power consumption of the present invention use the TX delay as the detection index of the first stage, which requires the support from the TX delay monitor 110 and the TX delay monitor driver 178. The TX delay monitor 110 records and monitors the period from time point T1 to time point T3 in FIG. 2, which is an operation with low power consumption. After the detection index of the first stage is confirmed, the wireless monitor 112 sends out the warning signal, so that the wireless network environment checker 114 performs the actions described in blocks 180 to 186 as the detection index of the second stage, which are operation with high power consumption. The electronic device 100 and the method to monitor the wireless network environment with low power consumption of the present invention can greatly reduce the number of detection times in the second stage with high power consumption, so as to achieve the purpose of reducing power consumption.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a transmitting (TX) delay monitor, configured to calculate a TX delay associated with a TX data packet, and send out a TX delay event in response to the TX delay associated with the TX data packet being longer than a predetermined period;
a wireless monitor, configured to receive the TX delay event and send out a warning signal based on the TX delay event; and
a wireless network environment checker, configured to check network communication environment in response to receiving the warning signal from the wireless monitor.

2. The electronic device as claimed in claim 1, wherein the wireless monitor performs a core algorithm to receive and monitor the TX delay event from the TX delay monitor, set parameters of the TX delay monitor, and send the warning signal to the wireless network environment checker based on the TX delay event.

3. The electronic device as claimed in claim 1, wherein the TX delay monitor performs a TX delay monitor driver to calculate the TX delay associated with the TX data packet, and send the TX delay event to the wireless monitor in response to the TX delay associated with the TX data packet being longer than the predetermined period.

4. The electronic device as claimed in claim 1, wherein the wireless network environment checker checks one or more of wireless signal Received Signal Strength Indication (RSSI), network latency, and network bandwidth in response to receiving the warning signal from the wireless monitor.

5. The electronic device as claimed in claim 1, wherein the TX delay monitor performs a TX delay monitor driver to record a first time point at which the TX data packet is sent to a hardware queue; the TX delay monitor performs the TX delay monitor driver to record a second time point at which the TX delay monitor receives an acknowledgement message from a router; the second time point is later than the first time point.

6. The electronic device as claimed in claim 5, wherein the TX delay monitor calculates the TX delay associated with the TX data packet by subtracting the first time point from the second time point.

7. The electronic device as claimed in claim 5, wherein the TX delay monitor is comprised in a wireless network device having a hardware queue for preparing to transmit the TX data packet to the router.

8. The electronic device as claimed in claim 5, wherein the acknowledgement message from the router is a layer-2 (L2) acknowledgement message.

9. The electronic device as claimed in claim 5, wherein the electronic device is connected to a network server through the router.

10. The electronic device as claimed in claim 9, wherein the TX delay monitor receives an Internet Protocol (IP) packet from the network server at a third time point, and the third time point is later than the second time point.

11. The electronic device as claimed in claim 2, wherein the parameters of the TX delay monitor comprise the predetermined period.

12. A method to monitor wireless network environment with low power consumption, applied to an electronic device comprising a wireless monitor, a TX delay monitor, and a wireless network environment checker, comprising:
by the TX delay monitor, calculating a TX delay associated with a TX data packet;
by the TX delay monitor, sending out a TX delay event in response to the TX delay associated with the TX data packet being longer than a predetermined period;
by the wireless monitor, receiving the TX delay event and sending out a warning signal based on the TX delay event; and
by the wireless network environment checker, checking the network communication environment in response to receiving the warning signal from the wireless monitor.

13. The method as claimed in claim 12, wherein the step of by the TX delay monitor calculating the TX delay associated with the TX data packet comprises:
by the TX delay monitor, recording a first time point at which the TX data packet is sent to a hardware queue;
by the TX delay monitor, recording a second time point at which the TX delay monitor receives an acknowledgement message from a router; and
by the TX delay monitor, calculating the TX delay associated with the TX data packet by subtracting the first time point from the second time point.

14. The method as claimed in claim 13, wherein the hardware queue stores the TX data packet prepared for transmitting to the router.

15. The method as claimed in claim 13, wherein the second time point is later than the first time point.

16. The method as claimed in claim 12, wherein the step of by the wireless network environment checker checking the network communication environment in response to receiving the warning signal from the wireless monitor comprises:
by the wireless network environment checker checking one or more of the wireless signal RSSI, network latency, and network bandwidth in response to receiving the warning signal from the wireless monitor.

17. The method as claimed in claim 12, further comprising:
by the wireless monitor, receiving and monitoring the TX delay event from the TX delay monitor; and
by the wireless monitor, setting parameters of the TX delay monitor.

18. The method as claimed in claim 17, wherein the parameters of the TX delay monitor comprise the predetermined period.

19. The method as claimed in claim 13, further comprising:
by the TX delay monitor receiving an Internet Protocol (IP) packet from a network server at a third time point.

20. The method as claimed in claim 19, wherein the third time point is later than the second time point.
